(19) United States
(12) Patent Application Publication
(10) Pub. No.: US 2009/0094223 A1
(43) Pub. Date: Apr. 9, 2009

(54) SYSTEM AND METHOD FOR CLASSIFYING SEARCH QUERIES

(76) Inventors: Matthew Berk, Seattle, WA (US); Walter Korman, San Francisco, CA (US); Yang Lim, San Francisco, CA (US)

Correspondence Address: PERKINS COIE LLP;PATENT-SEA, P.O. BOX 1247, SEATTLE, WA, 98111-1247, US

(21) Appl. No.: 11/868,398

(22) Filed: Oct. 5, 2007

(51) Int. Cl. G06F 17/30

(52) U.S. Cl. 707/5; 707/E17.108

(57) ABSTRACT

A search facility for classifying search queries prior to executing the search queries. The facility can receive a search query from a user and perform one or more of a set of evaluations of the search query to determine likely query classifications. The facility can also decompose the search query into constituent parts and perform one or more of a set of evaluations of the individual constituent parts to determine likely classifications. The facility can then arbitrate amongst the likely query classifications and rank the arbitrated likely query classifications. The ranked arbitrated query classifications can be mapped to data sources and services. The facility can retrieve content from the mapped data sources and services using the user's original search query. Each of the ranked arbitrated query classifications can correspond to a display region that can display content from the mapped one or more data sources and services to the user.

### BACKGROUND

It has become increasingly popular for search websites to allow users to search for content based upon type of content. Such search websites typically work by requiring a user to specify the desired content type (e.g., web search results, images, videos, audio, or news) in advance of submitting a search query. The search websites then search content sources associated with the specified content type and return search results to the user from those content sources. For example, the search website provided by Google™ allows a user to search indexes of web pages, images, videos, news stories and patents.

Another common approach of certain search websites is to offer categorized, or classified, search results. These search websites typically work by searching content sources using a user-submitted search query, and then categorizing or classifying the results obtained from the content sources. The categorized or classified results are then returned to the user. As an example, the Clusty search website groups similar search results together into topics, or clusters.

### BRIEF DESCRIPTION OF THE DRAWINGS

FIG. 1 is a block diagram that illustrates components of a search facility.

FIG. 2 is a flow diagram of a process for receiving the submission of a search query and returning search results.

FIG. 3 is a flow diagram of a process for determining query classes for a search query.

FIG. 4 is a flow diagram of a process for building a search results interface.

FIG. 5 is a representative screenshot depicting a search query and search results interface.

FIG. 6 is a representative screenshot depicting an administration interface for the search facility.

FIG. 7 is a representative screenshot depicting another administration interface for the search facility.

FIG. 8 is a representative screenshot depicting another administration interface for the search facility.

FIG. 9 is a representative screenshot depicting another administration interface for the search facility.

### DETAILED DESCRIPTION

A search facility for classifying search queries prior to executing the search queries is described herein. The facility can receive a search query from a user and perform one or more of a set of evaluations of the search query to determine likely query classifications. The facility can also decompose the search query into constituent parts and perform one or more of a set of evaluations of the individual constituent parts to determine likely classifications. The facility can then arbitrate amongst the likely query classifications and rank the arbitrated likely query classifications.

In some embodiments, the set of evaluations performed by the facility includes evaluating the search query against a first set of rules to determine if the search query exactly matches one or more of the first set of rules. The facility then determines whether one or more query classes associated with one or more of the exactly matched rules from the first set are likely query classes. The set of evaluations also includes evaluating the search query against a second set of rules to determine if the search query matches one or more of the second set of rules according to a regular expression pattern match. The facility then determines whether one or more query classes associated with one or more of the regular expression pattern matched rules from the second set are likely query classes. The set of evaluations also include evaluating the search query against one or more data models, against one or more indexes and against custom code-based classifiers. The facility determines likely query classes from these evaluations. The set of evaluations also includes decomposing the search query into its constituent parts and evaluating the constituent part to determine likely query classes. The facility can also use the constituent parts to determine sub-classifications of the search query and evaluate the sub-classifications to determine likely query classes. The facility can also evaluate the search query using other techniques to determine one or more likely query classes. The evaluations performed by the facility enable the facility to understand the semantic nature of the user's search query, rather than attempting to determine from the literal language of the user's search query which source to draw content from. Understanding the semantic nature of the user's search query enables the facility to provide content to the user that is meaningful to the user's search query.

In some embodiments, the facility returns one or more ranked arbitrated query classifications in response to the user's search query. Each of the one or more ranked arbitrated query classifications is mapped to one or more external and/or internal data sources and services. The facility retrieves content from the mapped one or more data sources and services using the user's original search query, and in some cases, additional context data. The facility can then place retrieved content corresponding to each of the ranked arbitrated query classifications in a display region for display to the user.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

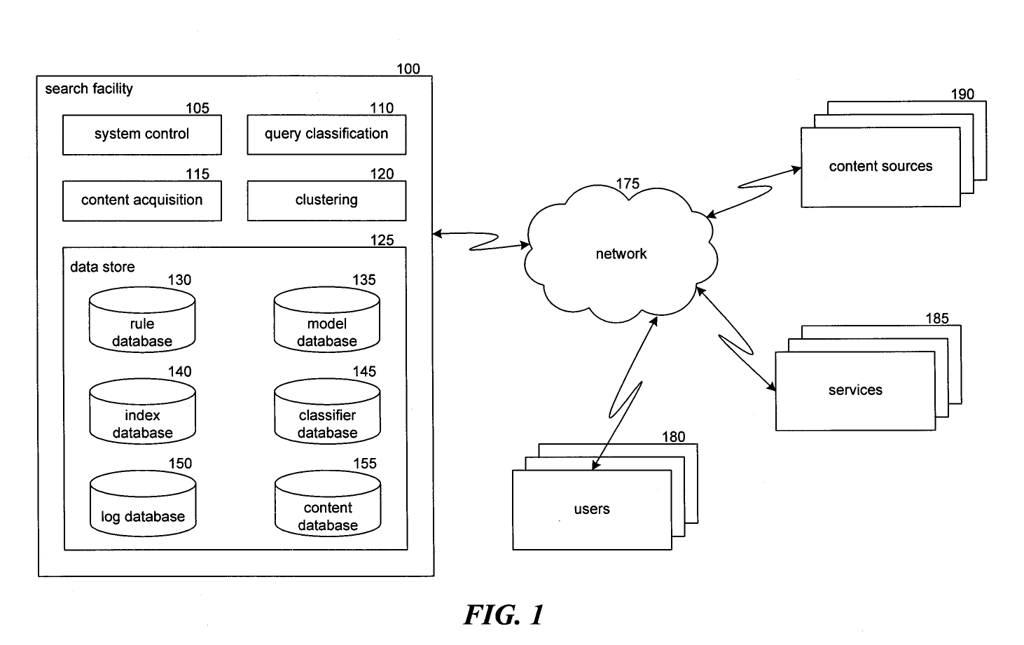

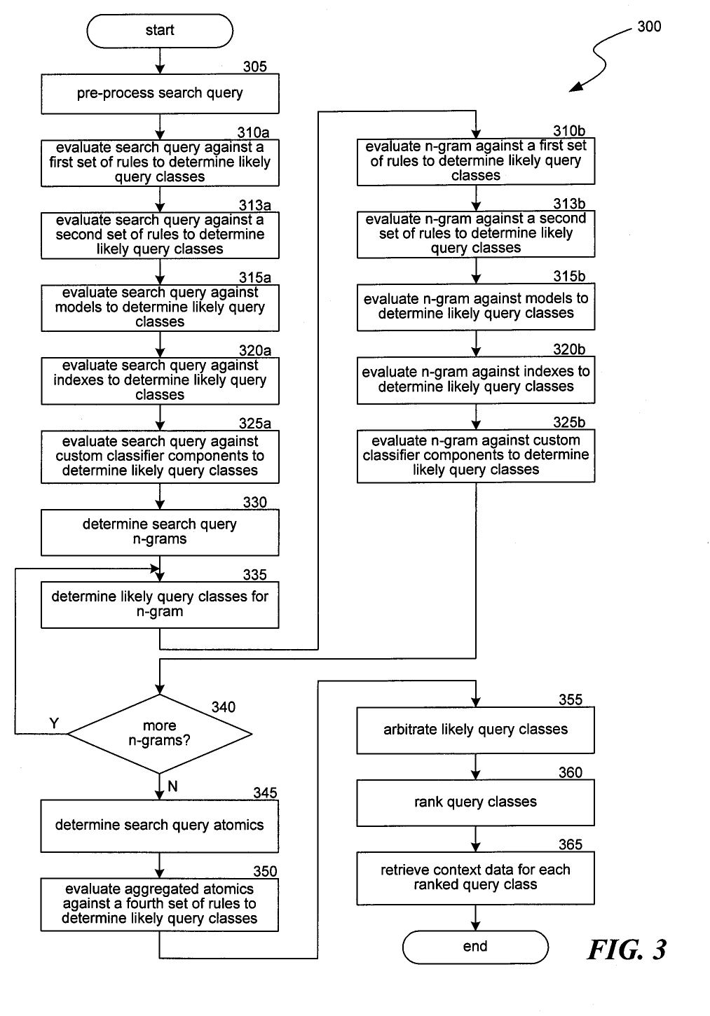

FIG. 1 is a block diagram illustrating components of a search facility 100 (“the facility”). Users 180 can submit search queries to the facility 100 via a public or private network 175, such as the Internet or an intranet. The users 180 may be actual humans, computer programs such as web spiders or crawlers, or other entities. The facility 100 has various components to receive search queries submitted by the users 180, process the search queries and return meaningful content to the users. These components include a system control component 105, a query classification component 110, content acquisition component 115, a clustering component 120 and a data store 125. When a user 180 submits a search query to the facility 100, the system control component 105 receives it and hands it off to the query classification component 110, which returns zero or more query classes and/or other data. Query classes are discussed in greater detail with reference to FIG. 3. The content acquisition component 115 uses the zero or more query classes and/or other data in order to determine which local or remote services 185 and/or content sources 190 to access to obtain content. Content can include search results, images, video, audio, content published via RSS as well as other types of data. The clustering component 120 can cluster certain content, such as search results, that is obtained from the services 185 and/or the content sources 190. The system control component 105 returns obtained content to the user 180. The various components of the facility 100 can retrieve and store data related to their functioning in the data store 125, which includes a rule database 130, a model database 135, an index database 140, a classifier database 145, a log database 150 and a content database 155.

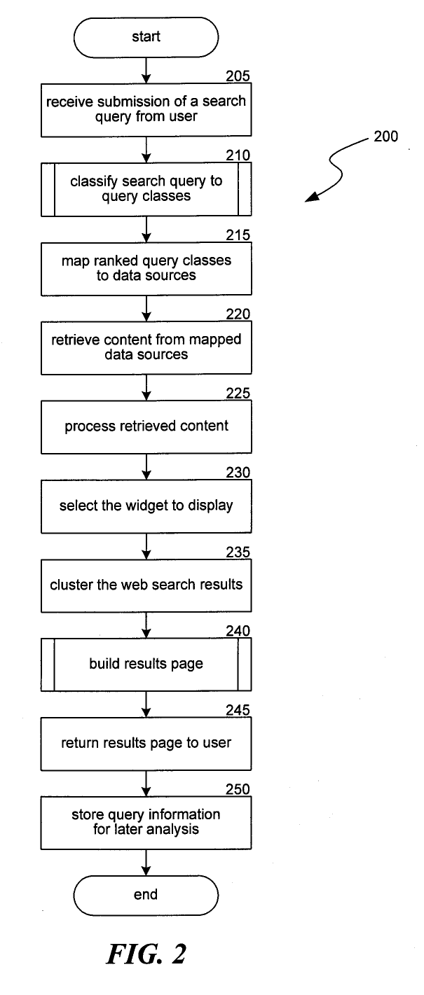

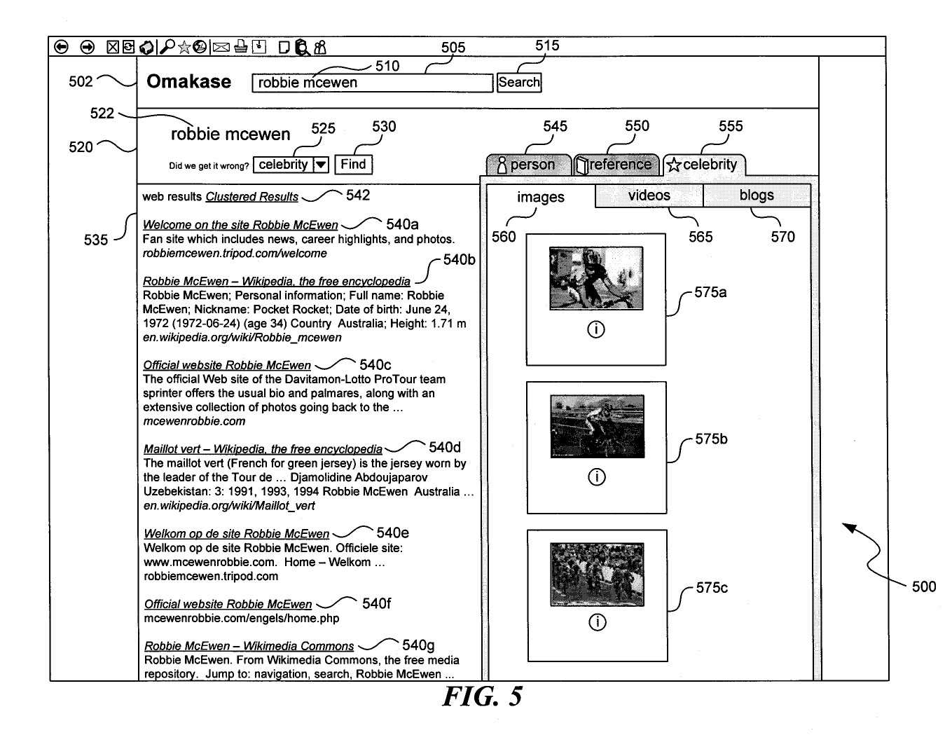

FIG. 2 is a flow diagram of a process 200 implemented by the facility for receiving a submission of a search query from a user and returning content to the user. At block 205, the facility receives the submission of a search query from a user. As is well understood in the art, a search query may include one or more words, characters, phrases and/or terms. As will be described with reference to FIG. 5, the user may additionally specify one or more query classes in the submission. At block 210, the facility classifies the received search query to zero or more query classes. This process is described in further detail with reference to FIG. 3.

FIG. 3 is a flow diagram of a process 300 implemented by the facility for classifying a received search query to zero or more query classes. A query class can represent a categorization or classification of a search query. In some embodiments, the facility classifies search queries to zero or more of the following query classes: “airport,” “celebrity,” “definition,” “dining,” “flight booking,” “flight status,” “government,” “health,” “hotel,” “image,” “local,” “mortgage calculator,” “movie,” “musician,” “navigation,” “news,” “person,” “place,” “product,” “reference,” “software,” “stock,” “team,” “video” and “weather.” In other embodiments, the facility can use query classes other than or in addition to these query classes.

One advantage of classifying search queries to query classes is that each query class can be associated with one or more internal and/or external data sources, such as the content database 155, the services 185 and/or the content sources 190 shown in FIG. 1. When the facility has classified a search query to a query class, the facility can then obtain content from the content database 155, the associated services 185 and/or the content sources 190. Such content may more closely match what the user is seeking with a search query. Another advantage is that by using query classes, the facility can present obtained content to the user in a logical and organized fashion. A third advantage to using query classes is that they can be chosen such that nearly all of the universe of possible search queries can be classified, thereby satisfying a vast majority of user searches. The facility can process search queries that cannot be classified to a query class by providing conventional web search results using techniques that are well-known in the art.

The process 300 begins at block 305 when the facility pre-processes the search query. In some embodiments, the facility pre-processes the search query by removing any definite articles. The facility may also pre-process the search query in other ways, such as by removing whitespace from the beginning and end of the search query, by removing any indefinite articles, or by other techniques known in the art. After pre-processing the search query, at block 310a the facility performs a first evaluation of the search query by evaluating the search query against a first set of rules, which can be stored in the rule database 130, to determine likely query classes. This evaluation is called “is.” Each rule in the first set of rules has an expression, a genre and a query class. For each rule, the expression includes one or more characters and the genre is “is,” which indicates that the rule represents an exact match. The facility evaluates the search query against the first set of rules (or a subset of the first set of rules) by comparing the search query to each rule's expression to determine if they exactly match. If so, then the facility determines that the rule's query class is a likely query class. An example of a rule which may be included in the first set of rules is “Lance Armstrong is a celebrity.” In this rule, the phrase “Lance Armstrong” is the expression, “is” is the genre and “celebrity” is the query class. If a user submits “Lance Armstrong” as a search query, in evaluating the search query against the first set of rules, the facility can determine that the search query exactly matches the expression “Lance Armstrong” in this particular rule and therefore that “celebrity” may be a likely query class for the user's search query.

At block 313a, the facility performs a second evaluation of the search query by evaluating the search query against a second set of rules, which can also be stored in the rule database 130, to determine likely query classes. This evaluation is called “matches.” Each rule in the second set of rules also has an expression, a genre and a query class. For each rule, the expression includes one or more characters and the genre is “matches,” which indicates that the rule represents a regular expression pattern match. Regular expression pattern matching, which is well-known to those of skill in the art, refers to using a string to match a different string according to certain syntax rules. The facility evaluates the search query against the second set of rules (or a subset of the second set of rules) by comparing the search query to each rule's expression to determine if there is a regular expression pattern match. If so, then the facility determines that the rule's query class may be a likely query class. An example of a rule which may be included in the second set of rules is “pictures of (.*) matches images.” In this rule, the phrase “pictures of (.*)” is the expression, “matches” is the genre, and “images” is the query class. If a user submits “pictures of bicycles” as a search query, in evaluating the search query against the second set of rules, the facility can determine that the search query is a regular expression pattern match of the expression “pictures of (.*)” in this particular rule and therefore that “images” may be a likely query class for the user's search query.

At block 315a, the facility performs a third evaluation of the search query by evaluating the search query against one or more pre-trained models, which can be stored in the model database 135, to determine likely query classes. This evaluation is called “conjures.” In some embodiments, one of the pre-trained models includes search query and destination data from prior user search query requests, such as search query and click-through data collected from users of America Online (AOL), and another of the pre-trained models includes normalized data from a directory, such as the directory produced by the Open Directory Project. The data in each of the pre-trained models can be organized by one or more topics. For each of the pre-trained models, the facility can evaluate the search query against the model's data to determine a statistical likelihood, or probability, that each topic is relevant to the search query. In some embodiments, the facility determines a statistical likelihood for each topic and then normalizes each statistical likelihood to a value between zero and one (non-inclusive). Each topic can be associated with one or more query classes. The facility can then determine that only the query classes associated with topics for which the normalized statistical likelihood is above a certain threshold, such as 0.8, may be likely query classes. In some embodiments the facility does not normalize the statistical likelihoods or use a cut-off threshold to determine likely query classes. Query classes can be enabled or turned on for the “conjures” evaluation by creating rules (which comprise a third set of rules) that can be stored in the rule database 130. An example of a rule that enables the query class “politics” for this evaluation is “aol conjures politics.” In this rule, “aol” is the expression, “conjures” is the genre and “politics” is the query class. This rule indicates that, if, in evaluating the search query against the pre-trained model that includes data from AOL users, the topic politics has a normalized statistical likelihood above the certain threshold, the facility can determine that the query class “politics” (because it is associated with the topic politics) is a likely query class. Other models can, of course, be specified that include data from users other than AOL users. Query classes can also be disabled or turned off for the “conjures” evaluation by deleting or disabling the corresponding rule.

At block 320a, the facility performs a fourth evaluation of the search query by evaluating the search query against one or more indexes, which can be stored in the index database 140. This evaluation is called “searches.” In some embodiments, one index is an index of place names, such as city, state and/or countries, and a second index is an index of references, such as the titles of entries in an online encyclopedia such as Wikipedia. The facility can also use indexes other than these two indexes. The facility evaluates the search queries against the indexes by comparing the search query to place names and/or references to determine if there are matches. The facility can use various search methods to compare the search query to place names and/or references to determine if there is are matches, including, but not limited to: exact matching, regular expression pattern matching, character overlap, token overlap, fuzzy matching, Boolean matching, and/or any other information retrieval methods. If the facility determines that the search query matches one or more place names and/or references, then the facility can determine that the query classes that correspond to the matching place names and/or references may be likely query classes. In some embodiments, the query class “place” is associated with the index of place names and the query class “reference” is associated with the index of references. As an example, if the user submits the search query “Robbie McEwen,” the facility can evaluate the search query against the indexes to determine if there is a match in either the index of place names or the index of references. In this example, the facility can determine that there is a match of the search query to an item in the index of references, and therefore that the query class “reference” is a likely query class.

At block 325a, the facility performs a fifth evaluation by evaluating the search query against one or more custom code-based classifiers, which can be contained in the classifier database 145. This type of evaluation is called “executes.” The facility can define one or more custom code-based classifiers to classify search queries that may not readily classify to one or more query classes. As an example, the facility can evaluate a search query against the one or more custom code-based classifiers to determine that the search query matches a domain name. The facility can associate domain names with the query class “navigation.” Continuing with this example, if a user submits as a search query the phrase “news.com,” the facility can evaluate the search query against the one or more custom code-based classifiers to determine that the query class “navigation” may be a likely query class. As another example, the facility can define a custom code-based classifier that performs one or more of the four evaluations discussed above, collects the likely query classes determined by the one or more evaluations, and arbitrates amongst the collected likely query classes to returned one or more likely query classes, based upon a score or other metric assigned to the query classes. One advantage of using custom code-based classifiers is that they provide flexibility and customization as to their inputs, outputs and methods used to determine likely query classes. Another advantage of using custom code-based classifiers is that the facility can determine likely query classes for unusual or non-standard search queries. The one or more custom code-based classifiers thus enable the facility to still determine a likely query class for search queries for which the facility does not determine a likely query class using the other evaluations discussed above.

At block 330, the facility determines the search query n-grams by decomposing the search query into its constituent n-grams. An n-gram, which is well-known in the art, is a subsequence of n items from a given sequence. At block 335, for each n-gram, the facility determines the likely query classes. The steps 310b-325b correspond to the steps 310a-325a performed to determine the likely query classes for the entire search query. At block 310b, the n-gram is evaluated against the first set of rules, which corresponds to block 310a. At block 313b, the n-gram is evaluated against the second set of rules, which corresponds to block 313a. At block 315b, the n-gram is evaluated against the one or more pre-trained models, which corresponds to block 315a. At block 320b, the n-gram is evaluated against the one or more indexes, which corresponds to block 320a. At block 325b, the n-gram is evaluated against the one or more custom code-based classifiers, which corresponds to block 325a. At block 340, the facility determines whether there are more n-grams in the search query. If there are, the process flow 300 returns to block 335. If not, the process flow 300 continues at block 345.

At block 345, the facility determines if there are any atomics contained in the search query. An atomic is a sub-classification of a search query or search query n-gram. The facility can use determined atomics individually for various purposes, such as providing context data. The facility can also aggregate atomics for the purpose of determining likely query classes. This aspect is further described with reference to block 350. In some embodiments, the facility sub-classifies search queries or search query n-grams to zero or more of the following atomics: “airline,” “airport,” “city,” “country,” “cuisine,” “first name,” “flight number,” “last name,” “local category,” “place,” “pure query,” “state” and “zip code.” In other embodiments, the facility can use atomics other than or in addition to these atomics. Each atomic can have one or more expressions associated with it, and search queries can be evaluated against these expressions to determine if there are any matches, either exact matches, regular expression pattern matches, fuzzy matches, Boolean matches, and/or matches according to any of the methods previously described. For example, the atomic “zip code” can have most or all of the zip codes in the United States associated with it. If a user submits the search query “weather in 98109,” the facility can evaluate the search query against the expressions associated with the atomics to determine that the token “98109” matches the expression “98109” associated with the atomic “zip code.” As a further example, a user could submit as a search query the phrase “Steven Jones.” The facility can compare the n-gram “Steven” with the expressions associated with the atomic “first name” to determine if there is a match. If so, then the n-gram “Steven” is an atomic “first name.” The facility can compare the n-gram “Jones” with the expressions associated with the atomic “last name” to determine if there is a match. If so, then the n-gram “Jones” is an atomic “last name.”

At block 350, the facility performs a sixth evaluation by evaluating the aggregated determined atomics against a fourth set of rules, which can be stored in the rule database 130, to determine likely query classes. This type of evaluation is called “aggregates.” If no atomics have been determined, the facility can skip this block and proceed to block 355. Each rule in the fourth set of rules has an expression, a genre and a query class. The facility can have rules of the form “atomic 1, atomic 2, . . . atomic n aggregate query class x.” For rules of this form, “atomic 1, atomic 2, . . . atomic n” is the expression, “aggregate” is the genre and “query class x” is the query class. Rules of the fourth set can also be of the form “atomic 1, string 1 aggregate query class y.” For rules of this form, “atomic 1, string 1” is the expression, “aggregate” is the genre and “query class y” is the query class. The string is typically a portion or component of the search query. Rules of the fourth set that have other forms are also possible. An example of a rule which may be included in the fourth set of rules is “first name, last name aggregate person.” In this example, “first name” and “last name” are atomics that together form the expression “first name, last name,” “aggregate” is the genre, and “person” is the query class. This rule indicates that the atomic “first name” and the atomic “last name” aggregate the query class “person.” Returning to the example of the previous paragraph, the facility can determine that the search query “Steven Jones” has the atomics “first name” and “last name.” The facility can then evaluate “first name, last name” against the fourth set of rules by comparing “first name, last name” to each rule's expression to determine if there is a match. If so, then the facility determines that the “person” query class may be a likely query class for the search query “Steven Jones.” Another example of an aggregate rule is “airline, flight number aggregate flight status.” In this example, “airline” and “flight number” are atomics and “flight status” is a query class. For the search query “Continental 540,” at the block 345 the facility can determine that it has the atomics “airline” and “flight number.” The facility can evaluate the determined atomics against the fourth set of rules (or a subset of the fourth set of rules) to determine that the determined atomics match the expression of the rule “airline, flight number aggregate flight status.” The facility can then determine that the “flight status” query class may be a likely query class for the search query “Continental 540.”

The facility can perform the six evaluations described with reference to blocks 310a-325a, 310b-325b and 350 in various orders. For example, the facility can perform the evaluations in the following order: “is,” “matches,” “aggregates,” “conjures,” “searches” and “executes.” Performing the evaluations in a specific order (although not necessarily in the listed order) enables the facility to use likely query classes determined during one evaluation in any subsequent evaluations that it performs. For example, suppose that the facility has determined that, during the course of the evaluation “is,” there is a high degree of confidence (as indicated by the score or confidence level) that a particular query class is highly relevant to a search query. The facility can then use that information to confirm or refute determinations of likely query classes that it makes during subsequent evaluations. As another example, if the facility determines that one evaluation finds that a particular query class is highly relevant to the search query, the facility can restrict subsequent evaluations to determining query classes that have a relation to or affinity with the particular highly relevant query class. In some embodiments, the facility can perform each evaluation without regard to likely query classes determined during the course of prior or subsequent evaluations, i.e., the facility can perform the evaluations in non-pipelined series. Alternatively, the facility can perform the evaluations in parallel or substantially in parallel to determine likely query classes.

It will be appreciated that the facility may perform less than the six previously-described evaluations. Any number of evaluations may be performed by the facility depending on the environment in which the facility is used and various other factors, such as the range of search queries that the facility is expected to receive. Moreover, the six evaluations described with reference to blocks 310a-325a, 310b-325b and 350 are not the only evaluations that the facility can perform to determine likely query classes for search queries. The facility can also perform other evaluations using search techniques and information retrieval methods known in the art that supplement the six evaluations. The evaluations performed by the facility, when viewed as a whole, form a modular, extensible framework for determining likely query classes for search queries. This modular, extensible evaluations framework enables the facility to focus on the semantic nature of a search query, instead of merely attempting to determine which content source to search. In other words, the evaluations framework enables the facility to attempt to understand the meaning of a user's search query, instead of simply positing that the user's search query corresponds to a particular content source. Evaluations can be added and removed as necessary by the facility for optimal determination of likely query classes.

In some embodiments, the facility can perform evaluations in addition to, or other than, the evaluations described above to determine likely query classes for search queries. Or, the facility can perform a subset of the evaluations, such as only the evaluations “is” and “matches” to determine likely query classes for search queries. Those of skill in the art will understand that the facility can adopt various configurations of the evaluations it performs to determine likely query classes for search queries. The facility can also change configurations of the evaluations it performs on a periodic or ad-hoc basis or as the facility learns from interactions with users.

At block 355, the facility collects any and all likely query classes that may have been determined in blocks 310a-325a, 310b-325b and 350 for the arbitration phase of the process 300. At this point, each of the collected likely query classes has a metric, such as a weight, score, priority, confidence level or other value, associated with it that serves as an assessment of the facility's determination that the likely query class is relevant to the original search query. The facility arbitrates among the collected likely query classes using the associated metrics to determine one or more query classes that are most relevant to the user's query. During this arbitration phase, the facility may eliminate some of the collected likely query classes if their associated metrics do not meet or exceed a pre-defined threshold. At block 360, the facility ranks the arbitrated query classes that have not been eliminated. The arbitrated query classes are ranked in order of most specific to least specific (e.g., in some cases the query class “flight booking” can be considered to be more specific than the query class “airport”). However, the facility can rank the arbitrated query classes using other techniques. In some embodiments, the facility ranks a maximum of four query classes. However, in other embodiments, the facility can rank a different number of query classes.

At block 365, the facility retrieves context data for each ranked query class. Alternatively, the facility can retrieve context data for all determined likely query classes. Additionally or alternatively, the facility can retrieve context data for determined atomics. Context data includes related data returned with a query class or atomic that can be used to supplement a query class. For example, a query class such as “place” may have context types “city,” “country,” “latitude” and “longitude” associated with it. Then, if the facility determines that a search query results in a ranked query class of “place,” the facility can retrieve context data corresponding to the associated context types to supplement the ranked query class. One advantage of retrieving context data is that the facility can use it to retrieve additional information from external and/or internal data sources to provide for a richer source experience for the user. As an example, a search query such as “weather in 98109” can result in a ranked query class of “place.” The facility can return context data that includes the following: “city: Seattle, state: Washington, country: United States, latitude: 47°, longitude: −122°.” At the completion of block 365, the process 300 ends.

Returning to FIG. 2, at the completion of block 210, the facility has returned zero or more ranked query classes. If at least one ranked query class has been returned, the highest ranked query class becomes the selected query class. At block 215, the facility maps the ranked query classes to external and/or internal data sources, such as the content database 155, the services 185 and/or the content sources 190 depicted in FIG. 1. Each query class can be mapped to one or more external and/or data sources. For example, the “celebrity” query class can be mapped to the following external data sources: a photography web site, such as flickr.com; a celebrity news web site, such as people.com; a reference web site, such as wikipedia.com; a video web site, such as youtube.com; and/or a blog web site, such as blogger.com. Each query class can also inherit a default set of external and/or internal data sources to retrieve content from, such as the following external data sources, which provide web search results: enhance.com, yahoo.com and msn.com. Therefore, the facility can obtain content for the “celebrity” query class from the following external data sources: flickr.com, people.com, wikipedia.com, youtube.com, blogger.com, enhance.com, yahoo.com and msn.com. In some embodiments, if the facility has not returned any ranked query classes at block 210, then the facility can still use the inherited default set of external and/or internal sources to obtain content.

At block 220, the facility retrieves content from the mapped external and/or internal data sources by searching the mapped external and/or internal data sources with the user's original search query. In some embodiments, the facility also uses retrieved context data to search the mapped external and/or internal data sources. In some embodiments, the facility pre-processes or otherwise alters the user's original search request for the mapped external and/or internal data sources. In some embodiments, the facility only searches the external and/or internal data sources mapped to the top-ranked query class. In some embodiments, the facility searches the external and/or internal data sources mapped to all the query classes, but only returns the content from the external and/or internal data sources mapped to the top-ranked query class. The facility can cache content from the external and/or internal data sources mapped to the non-top-ranked query classes for the possibility that this content is requested by the user.

At block 225, the facility processes the retrieved content. In some embodiments, the facility places the content retrieved from the external and/or internal data sources corresponding to the top-ranked query class into a primary widget for eventual display. A widget is a display region that can correspond to a query class, and can display content from the data sources that the query class has been mapped to. The facility can also collect the content retrieved from the inherited default set of external and/or internal data sources (e.g., enhance.com, yahoo.com and msn.com) for eventual display in a web results region. At block 230, the facility selects the widgets to display. In some embodiments, the widgets map directly to the ranked query classes. For example, the “celebrity” query class maps to a “celebrity” widget. In other embodiments, the ranked query classes may not map directly to widgets. At block 230 the facility also determines the primary widget for eventual display to the user.

At block 235, the facility clusters content retrieved from the inherited data sources. This content can include web search results. Clustering, which is well understood in the art, refers to the grouping of similar or related web search results into descriptive clusters or groups. In some embodiments, the content is not clustered. In some embodiments, if the facility has not returned any ranked query classes, then the facility displays only the clustered web search results to the user.

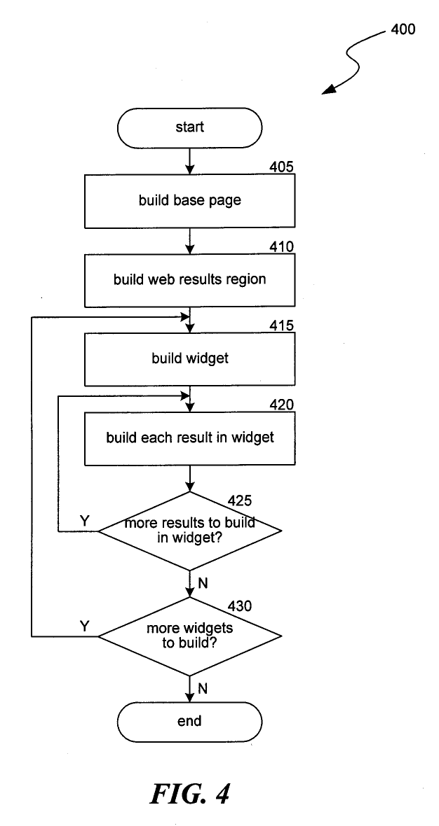

At block 240, the facility builds a search results page. FIG. 4 illustrates a process 400 implemented by the facility for building a search results page. At block 405, the facility builds a base page. At block 410, the facility builds the web results region, which contains the web search results. At block 415, the facility builds the primary widget, i.e., the widget corresponding to the top-ranked query class. At block 420, the facility builds a result in the primary widget. The facility determines whether there are more results to build in the primary widget at block 425. If so, the process 400 returns to block 420, and if not, the process 400 continues to block 430. At block 430, the facility determines whether there are more (non-primary) widgets to build. In some embodiments, the facility may build only the primary widget, and build the secondary widgets when a user requests their display. In other embodiments, however, the facility builds both the primary and secondary widgets so that the secondary widgets are ready for display when requested by a user. If there are more widgets to build, the facility returns to step 415. If not, the process 400 ends.

Returning to FIG. 2, at the completion of the block 240, the facility has built the search results page according to the process 400 illustrated in FIG. 4. At block 245, the facility returns the search results page to the user. At block 250, the facility stores search query information, such as the query information obtained during processing and classifying the search query, and other information in the data store 125, such as in the log database 150 shown in FIG. 1. The logged search query information can be used for further analysis by the facility, such as to create, edit, modify or delete query classes and/or atomics. At the completion of the block 250, the process 200 ends.

One advantage of the facility is that it does not require a user to specify a desired type of content in advance of submitting a search query. Rather, the facility can determine the relevant query classes and then retrieve various types of content that correspond to the relevant query classes. This enables the facility to forego searching for a wide array of content that is not relevant to the user's search query. For example, if the facility determines that the only query class relevant to the user's search query is the “flight status” query class, the facility can forego searching for images and video, as these types of content are likely not of interest to the user. Another advantage of the facility is that it because it determines which query classes are most relevant to the user's search query and then displays content drawn from data sources corresponding to those query classes, the facility provides content that is highly relevant to the user's search query.

FIG. 5 is a representative screenshot depicting a search query and search results interface 500. The interface 500 includes a number of different regions for the submission of a search query and the display of query results. One such region is search region 502. Search region 502 contains a text box 505, into which a user can type or enter a search query, such as the search query “robbie mcewen.” The user can submit the search query 510 to the facility by clicking on the button 515 labeled “Search.”

The search query interface 500 also includes web results region 535. The web results region 535 displays an ordered listing of relevant web search results, shown individually as web search results 540a-g. The web results region also contains a link 542 that enables the user to instruct the facility to display the web search results in a clustered format. The facility can build the web results region 535 as described with reference to block 410 of FIG. 4.

The search query interface 500 also includes several widgets: a “person” widget 545, a “reference” widget 550 and a “celebrity” widget 555. The widgets correspond to the ranked query classes that the facility has determined for the search query 510. As shown, the “person” widget 545 is displayed in the left-most position, indicating that the facility has determined it is the primary widget. The “reference” 550 and “celebrity” 555 widgets are secondary widgets and are displayed to the right of the “person” widget 545 in the order of the ranking of their corresponding query classes. That is, the facility ranked the query class corresponding to the “person” widget first, the query class corresponding to the “reference” widget second, and the query class corresponding to the “celebrity” widget third.

The widgets contain content that has been retrieved from one or more external and/or internal data sources. For the “celebrity” widget 555, the retrieved content has been divided into three sub-widgets: an “images” sub-widget 560, a “videos” sub-widget 565 and a “blogs” sub-widget 570. As shown, the “images” sub-widget 560 displays one or more images, shown individually as images 575a-c, that the facility may have obtained from a photography web site. Similarly, the “videos” sub-widget 565 can display one or more videos obtained from video external and/or internal data sources, and the “blogs” sub-widget 570 can display one or more items of content retrieved from blog external and/or internal data sources.

The search query interface 500 also includes a feedback region 520 that displays the initial search query 522 “robbie mcewen” submitted by the user. The feedback region 520 also includes a list box 525 which contains a list of available query classes that the user can select to display content in a widget other than the widgets 545, 550 and 555 shown. For example, if the user determines that the more relevant query class and widget to the search query 522 “robbie mcewen” is “news,” instead of “celebrity,” the user can select “news” from the list box 525 and click the button 530. Upon doing so, the user re-submits the search query 510, along with an indication of the user-selected query class taken from the text box 525, to the facility. The facility can then return a new search query results page to the user that shows the widget corresponding to the user-selected query class as the primary widget. The facility can also return new web search results to the user based upon this user-selected query class. The use of widgets to display search results and the feedback region to refocus a search query allows a user to quickly and easily identify relevant search results.

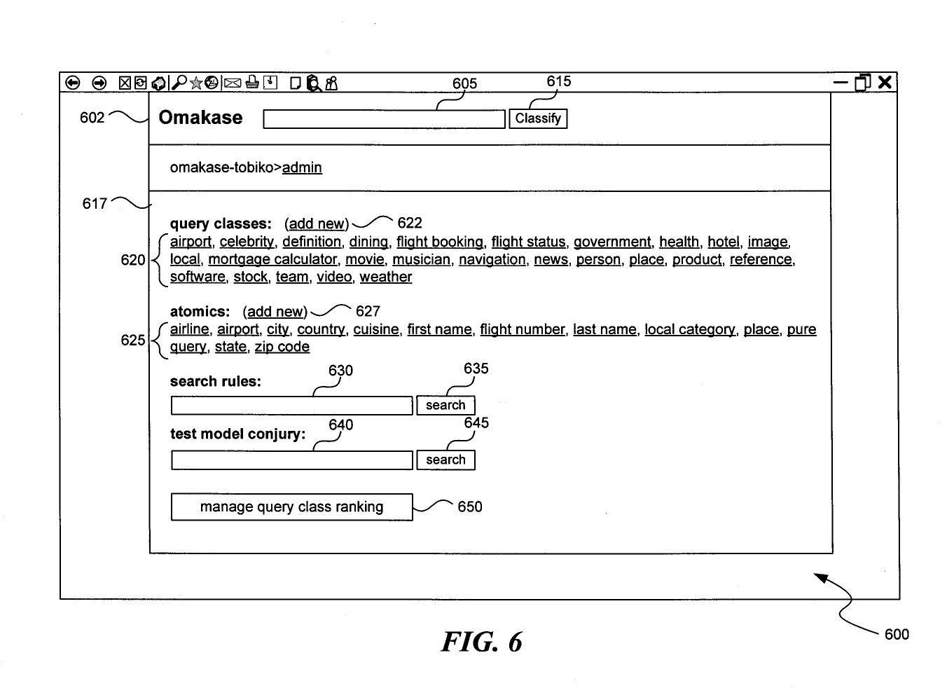

FIG. 6 is a representative screenshot depicting an administration interface 600 for the facility. The administration interface 600 includes a number of different regions that enable administration of the facility. One such region is classification region 602. Classification region 602 contains a text box 605, into which an administrator can type or enter a search query to be classified. The administrator can submit a search query to be classified by clicking on the button 615 labeled “Classify.” Upon doing so, the facility classifies the search query according to the process described in the process 300 of FIG. 3, and displays the ranked query classes. The administrator can thus test the facility's query classification capabilities to ensure that it is returning relevant query classes. In some embodiments, the facility can test the facility's query classification capabilities by automatically submitting sample search queries and comparing the determined likely query classes with pre-determined desired classifications to ensure that the facility is returning relevant query classes. Such automatic testing can be performed by the facility on a scheduled or ad-hoc basis.

The administration interface 600 also includes a region 617 that contains a number of different tools for administering the facility. The region 617 includes query classes 620, any one of which can be edited by selecting the corresponding link. A new query class can be added by selecting link 622. The region 617 also includes a listing of the atomics 625. An atomic can also be edited by selecting the corresponding link, and a new atomic can be added by selecting link 627. The facility's rules (e.g., the rules associated with the genres “is,” “matches,” “conjures” and “aggregates,” and/or other rules) can be searched by entering a term into text box 630 and clicking button 635. Similarly, the facility's one or more pre-trained models can be tested by entering a search query into text box 640 and clicking button 645. Lastly, the administrator can manage the rankings of the query classes by clicking button 650.

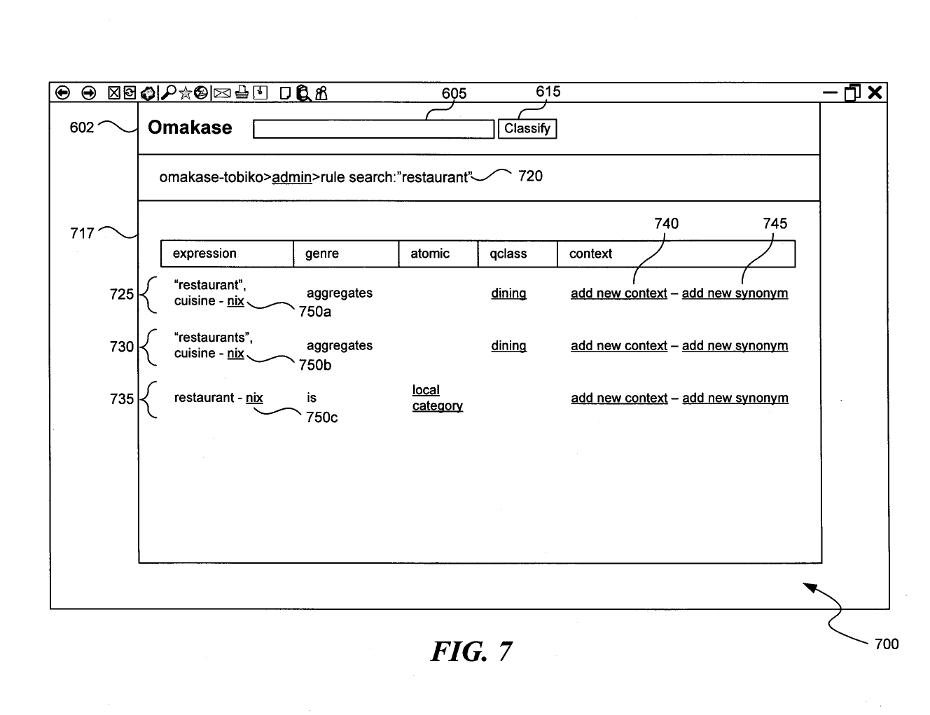

FIG. 7 is a representative screenshot depicting another administration interface 700 for the facility that can be displayed in response to a search of the facility's rules, such as by entering a term into box 630 of FIG. 6. In this screenshot, a search for rules containing the word “restaurant” has been performed, as indicated by a search path string 720. The administrator can perform this search, for example, to see all of the rules that match (exactly and/or otherwise) the word “restaurant” for purposes of editing, deleting or creating new rules associated with the word. The region 717 includes a listing of the rules matching the word “restaurant.” These include rule 725, which is a rule of the genre “aggregates.” As depicted, the rule 725 is “‘restaurant’, cuisine aggregates dining.” This indicates that search queries and/or n-grams that contain the word “restaurant” and an n-gram matching atomic “cuisine” will indicate the “dining” query class. Rule 730 is a slight variation of rule 725 with “restaurants” as plural. Rule 735 is a rule of the type “is.” Rule 735 is “restaurant is [atomic] local category.” This indicates that search queries and/or n-grams that include the word “restaurant” can match the atomic “local category.”

Region 717 also contains a link 750 (shown individually as links 750a-c) that can be selected to delete the corresponding rules 725, 730 or 735. Rule 725 also has two links associated with it in the context column: a link 740 to add new context data to the rule 725 and a link 745 to add a new synonym, which enables the administrator to instruct the facility to copy or clone the rule 725, with perhaps a slight variation of the original. Rules 735 and 740 also have links to add context data and/or a new synonym to each rule.

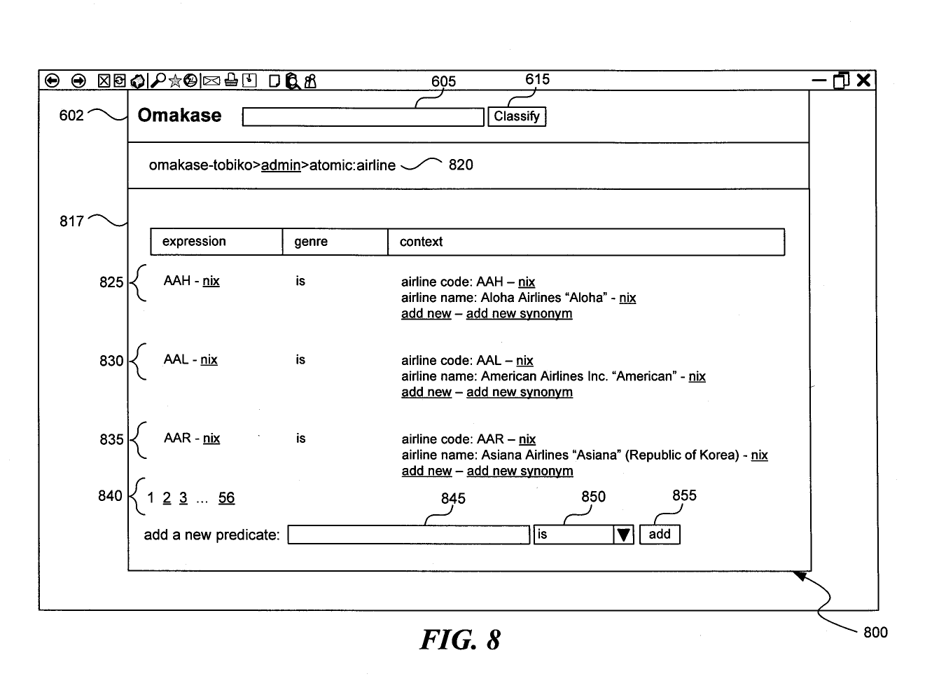

FIG. 8 is a representative screenshot depicting another administration interface 800 for the facility that can be displayed to edit an atomic. The administrator can access interface 800 by selecting the link in FIG. 6 that corresponds to the atomic 625 desired to be edited. In this interface 800, the atomic that has been selected to be edited is “airline” as reflected by a search path string 820. In the region 817 are listed three expressions associated with this atomic. Expression 825 is “AAH” and corresponds to the rule “AAH is an airline.” Expression 830 is “AAL” and corresponds to the rule “AAL is an airline.” Expression 835 is “AAR” and corresponds to the rule “AAR is an airline.” Each expression also has context data associated with it, such as the airline code and the airline name. Links 840 link to other pages of expressions associated with the “airline” atomic. An administrator can create new rules by entering an expression into text box 845, selecting the genre in list box 850, and clicking button 855. For example, to create the rule “AJO is an airline,” an administrator can type “AJO” into text box 845, select the genre “is” in list box 850, and click button 855 to submit the rule. The list box 850 also can contain other genres, such as “matches,” which corresponds to regular expression pattern matching, “conjures,” which corresponds to the one or more pre-trained models, “aggregates,” which corresponds to aggregating atomics and/or other genres.

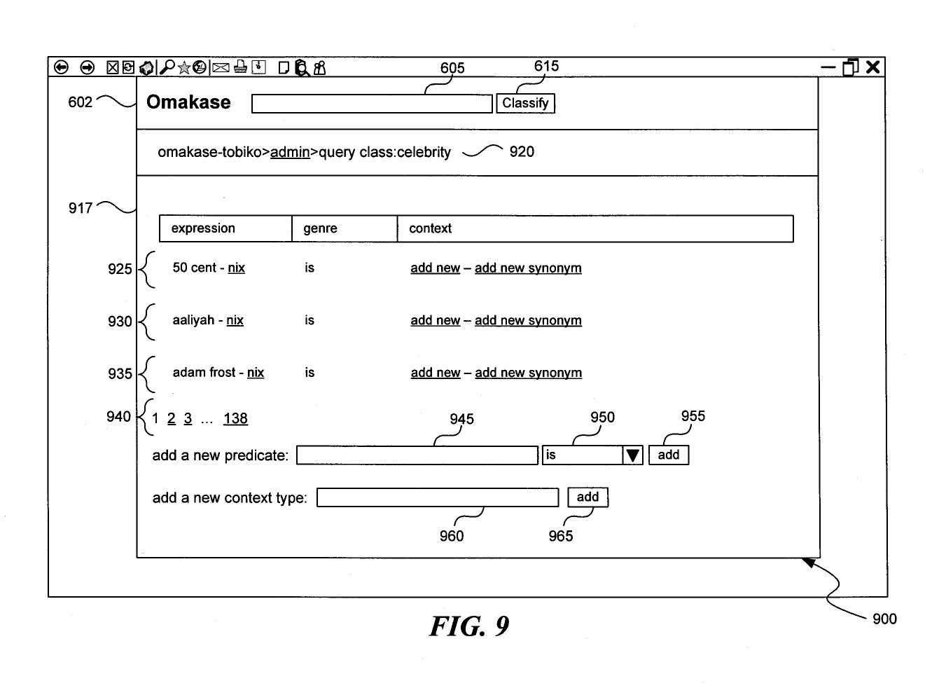

FIG. 9 is a representative screenshot depicting another administration interface 900 for the facility that can be displayed to edit a query class. The administrator can access interface 900 by selecting the link in FIG. 6 that corresponds to the query class 620 desired to be edited. In this interface 900, the atomic that has been selected to be edited is “celebrity” 920. In the region 917 are listed three expressions associated with this query class. Expression 925 is “50 cent” and corresponds to the rule “50 cent is a celebrity.” Expression 930 is “aaliyah” and corresponds to the rule “aaliyah is a celebrity.” Expression 935 is “adam frost” and corresponds to the rule “adam frost is a celebrity.” Each expression also can have context data associated with it. Links 940 link to other pages of expressions associated with the query class celebrity. An administrator can create new rules by entering an expression into text box 945, selecting the proper genre in list box 950, and clicking button 955. For example, to create the rule “adam sandier is a celebrity,” an administrator can type “adam sandler” into text box 945, select the genre “is” in list box 950, and click button 955 to submit the rule. Similar to the list box 850 of FIG. 8, the list box 950 also can contain the other genres: “matches,” “conjures,” “aggregates,” “searches” and “executes.” An administrator can also add new context types that apply to all the rules associated with the query class “celebrity” by inputting a new context type in text box 960 and clicking button 965.

The administrative interfaces disclosed herein facilitate the management and optimization of a facility that performs search query classification prior to searches being executed. As feedback is received from users and other sources, query classes, atomics, and other rules can be easily added, modified, or deleted in order to improve the performance of the facility. Such flexibility allows the facility to be implemented in a broad variety of general and specific environments.

While various embodiments are described in terms of the environment described above, those skilled in the art will appreciate that various changes to the facility may be made without departing from the scope of the invention. For example, rule database 130, model database 135, index database 140, classifier database 145, log database 150 and content database 155 are all indicated as being contained in a general data store 125. Those skilled in the art will appreciate that the actual implementation of the data store 125 may take a variety of forms, and the term “database” is used herein in the generic sense to refer to any data structure that allows data to be stored and accessed, such as tables, linked lists, arrays, etc.

Those skilled in the art will also appreciate that the facility may be implemented in a variety of environments including a single, monolithic computer system, a distributed system, as well as various other combinations of computer systems or similar devices connected in various ways. Moreover, the facility may utilize third-party services and data to implement all or portions of the information functionality. Those skilled in the art will further appreciate that the steps shown in FIGS. 2-4, may be altered in a variety of ways. For example, the order of the steps may be rearranged, substeps may be performed in parallel, steps may be omitted, or other steps may be included.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A method in a computing system of displaying search results to a user, the method comprising:
receiving a search query from a user;
performing one or more evaluations of the search query to identify a plurality of query classifications related to the search query;
prioritizing the identified plurality of query classifications in accordance with the relevance of the plurality of query classifications to the search query, wherein each of the query classifications has a rank;
identifying one or more data sources that are mapped to at least some of the identified plurality of query classifications, wherein the one or more data sources are identified based at least partially upon the identified plurality of query classifications;
applying the search query against the identified one or more data sources and receiving content from the one or more data sources responsive to the search query; and
displaying the received content from the one or more data sources to the user, wherein the received content associated with a query classification having a higher ranking is displayed more prominently than the received content associated with a query classification having a lower ranking.

2. The method of claim 1 wherein performing one or more evaluations of the search query includes:
performing a first evaluation of the search query that identifies a first query classification related to the search query; and
performing a second evaluation of the search query, subsequent to the first evaluation, that identifies a second query classification related to the search query, wherein the first query classification at least partially determines the second query classification.

3. The method of claim 1 wherein the received content associated with a query classification is displayed in a widget.

4. The method of claim 3 wherein a widget associated with a query classification having a lower ranking is not displayed to a user.

5. The method of claim 3 wherein widgets are displayed side-by-side to a user.

6. The method of claim 3 wherein widgets are displayed in a tabbed display to a user.

7. The method of claim 1, further comprising:
determining context data associated with at least one of the plurality of query classifications;
applying the context data with the search query against the identified one or more data sources and receiving content from the one or more data sources responsive to the context data; and
displaying the received content responsive to the context data to the user.

8. A method of displaying search results to a user, the method comprising:
receiving a search query from a user;
evaluating the search query to identify a plurality of query classifications related to the search query;
prioritizing the identified plurality of query classifications in accordance with the relevance of the plurality of query classifications to the search query, wherein each of the identified plurality of query classes has a rank;
mapping the top-ranked query classification to one or more data sources;
retrieving a first set of content from the one or more data sources using the search query; and
displaying the retrieved first set of content to the user.

9. The method of claim 8 wherein evaluating the search query includes:
determining if there is an exact match of the search query and one or more of a first set of rules to determine a first set of query classifications; and
determining if there is a regular expression match of the search query and one or more of a second set of rules to determine a second set of query classifications.

10. The method of claim 8 wherein evaluating the search query includes evaluating the search query against one or more statistical models.

11. The method of claim 8 wherein evaluating the search query includes evaluating the search query against one or more indexes.

12. The method of claim 8 wherein evaluating the search query includes evaluating the search query against one or more code-based classifiers.

13. The method of claim 8, further comprising:
decomposing the search query into at least one n-gram; and
evaluating the n-gram to identify a plurality of query classifications related to the n-gram.

14. The method of claim 8, further comprising:
decomposing the search query into multiple n-grams; and
evaluating the multiple n-grams to identify a first set of atomics.

15. The method of claim 8, further comprising arbitrating amongst the identified plurality of query classes, wherein the arbitration takes into account the score of each of the identified plurality of query classes.

16. The method of claim 8, further comprising:
determining context data for the top-ranked query classification;
retrieving a second set of content from the one or more data sources using the context data; and
displaying the retrieved second set of content to the user.

17. A system for displaying search results to a user, the system comprising:
a component that receives a search query from a user;
a query analysis component that performs one or more evaluations of the search query to identify a plurality of query classifications related to the search query, the query analysis component scoring the identified plurality of query classifications in accordance with the relevance of the plurality of query classifications to the search query, wherein each of the identified plurality of query classes has a rank:
a query application component that maps the top-ranked query class to a content source, applies the search query against the content source, and receives content from the content source responsive to the search query; and
a display component that displays the received content to the user.

18. The system of claim 17, wherein the query analysis component further determines if there is an exact match of the search query and one or more of a first set of rules to determine a first set of query classifications, and determines if there is a regular expression match of the search query and one or more of a second set of rules to determine a second set of query classifications.

19. The system of claim 17, wherein the query analysis component further evaluates the search query against one or more statistical models.

20. The system of claim 17, wherein the query analysis component further evaluates the search query against one or more indexes.

21. The system of claim 17 wherein the display component is a widget.

22. A method of classifying a search query, the method comprising:
receiving a search query;
evaluating the search query to identify a plurality of query classifications related to the search query; and
prioritizing the identified plurality of query classifications in accordance with the relevance of the plurality of query classifications to the search query.

23. The method of claim 22 wherein evaluating the search query includes:
determining if there is an exact match of the search query and one or more of a first set of rules to determine a first set of query classifications; and
determining if there is a regular expression match of the search query and one or more of a second set of rules to determine a second set of query classifications.

24. The method of claim 22 wherein evaluating the search query includes evaluating the search query against one or more statistical models.

25. The method of claim 22 wherein evaluating the search query includes evaluating the search query against one or more indexes.

26. The method of claim 22 wherein evaluating the search query includes evaluating the search query against one or more code-based classifiers.

27. The method of claim 22, further comprising:
decomposing the search query into at least one n-gram; and
evaluating the n-gram to identify a plurality of query classifications related to the n-gram.

28. The method of claim 22, further comprising:
decomposing the search query into multiple n-grams; and
evaluating the multiple n-grams to identify a first set of atomics.

29. The method of claim 28, further comprising evaluating the first set of atomics to identify a second plurality of query classifications related to the first set of atomics.

30. The method of claim 29 wherein evaluating the first set of atomics includes:
aggregating a first atomic and a second atomic; and
evaluating the aggregated atomics to identify a second plurality of query classifications related to the aggregated atomics.

31. The method of claim 29 wherein evaluating the first set of atomics includes:
aggregating an atomic and another component of the search query; and
evaluating the aggregated atomic and the other component of the search query to identify a second plurality of query classifications related to the aggregated atomic and the other component.

32. The method of claim 22 wherein each of the identified plurality of query classes has a rank, and further comprising:
mapping the top-ranked query classification to one or more data sources; and
retrieving a first set of content from the one or more data sources using the search query.

33. The method of claim 22, further comprising:
determining context data for the top-ranked query classification; and
retrieving a second set of content from the one or more data sources using the context data.

34. A method of classifying a search query prior to executing the search query, the method comprising:
receiving a search query from a user;
evaluating the search query against a first set of rules to determine a first set of likely query classifications, wherein the evaluation determines if there is an exact match of the search query and one or more of the first set of rules;
evaluating the search query against a second set of rules to determine a second set of likely query classifications, wherein the evaluation determines if there is a regular expression match of the search query and one or more of the second set of rules;
ranking the first and second sets of likely query classifications, wherein the ranking determines a top-ranked query classification applicable to the search query; and
mapping the top ranked query classification to one or more sources of content prior to executing the search query.

35. The method of claim 34, further comprising evaluating the search query against a statistical model to determine a third set of likely query classifications.

36. The method of claim 34, further comprising evaluating the search query against an index to determine a third set of likely query classifications.

37. The method of claim 34, further comprising evaluating the search query against a code-based classifier to determine a third set of likely query classifications.

38. The method of claim 34, further comprising:
decomposing the search query into at least two constituent portions; and
evaluating a first constituent portion against a third set of rules to determine a first atomic.

39. The method of claim 38, further comprising:
aggregating the first atomic and a second constituent portion; and
evaluating the aggregated first atomic and second constituent portion against a fourth set of rules to determine a third set of likely query classifications.

40. The method of claim 34, further comprising applying the search query against the one or more sources of content and receiving content responsive to the search query.

41. A system for classifying a search query, the system comprising:
a component that receives a search query;
an evaluation component that performs one or more evaluations of the search query to identify a plurality of query classifications related to the search query; and
a scoring component that scores the identified plurality of query classifications in accordance with the relevance of the plurality of query classifications to the search query.

42. The system of claim 41, wherein the evaluation component further determines if there is an exact match of the search query and one or more of a first set of rules to determine a first set of query classifications, and determines if there is a regular expression match of the search query and one or more of a second set of rules to determine a second set of query classifications.

43. The system of claim 41, wherein the evaluation component further evaluates the search query against one or more statistical models.

44. The system of claim 41, wherein the evaluation component further evaluates the search query against one or more indexes.

45. The system of claim 41, wherein the evaluation component further evaluates the search query against one or more code-based classifiers.

46. The system of claim 41 wherein each of the identified plurality of query classes has a rank, and further comprising:
a component that maps the top-ranked query class to a content source;
a component that applies the search query against the content source; and
a component that receives content from the content source responsive to the search query.
